(19) United States
(12) Patent Application Publication
(10) Pub. No.: US 2020/0050275 A1
(43) Pub. Date: Feb. 13, 2020

(54) METHOD AND APPRATUS FOR HUMAN-MACHINE INTERACTION, TERMINAL, AND COMPUTER-READABLE STORAGE MEDIUM

(71) Applicant: AAC Technologies Pte. Ltd., Singapore city (SG)

(72) Inventors: Xueli Gao, Shenzhen (CN); Xiang Ding, Shenzhen (CN)

(21) Appl. No.: 16/528,692

(22) Filed: Aug. 1, 2019

(30) Foreign Application Priority Data
Aug. 8, 2018 (CN) 201810895923.6

(51) Int. Cl. G06F 3/01; G06F 3/041

(52) U.S. Cl. CPC G06F 3/016; G06F 3/041

(57) ABSTRACT

A method and apparatus for human-machine interaction, a terminal, and a computer-readable storage medium are provided. The method for human-machine interaction of the present disclosure includes: receiving interaction information of a user acquired by a sensor, wherein the sensor includes a sensor that acquires the interaction information by means of a touch manner; determining a reply control signal corresponding to the interaction information, wherein the reply control signal includes a tactile reply control signal and a visual reply control signal; and generating a tactile reply response according to the tactile reply control signal, and generating a visual reply response according to the visual reply control signal, wherein the tactile reply response is used to provide the user with a response action for a tactile stimulus, and the visual reply response is used to provide the user with a visible response action.

### TECHNICAL FIELD

The present disclosure relate to the field of communication technologies, and more particularly, to a method and apparatus for human-machine interaction, a terminal, and a computer-readable storage medium.

### BACKGROUND

With the continuous development of science and technology, users currently achieve human-machine interaction with terminals via input devices (such as keyboards, touch screens, etc.). Processors in the terminals acquire interaction information of the users via the devices such as the keyboards or the touch screens, and respond according to the interaction information, thereby achieving the human-machine interaction with the users.

The inventor finds that there are at least the following problems in the prior art: at present, the users usually input the interaction information to the terminals by means of a touch manner. After the users input the interaction information, if the terminals process the interaction information slowly, the users may not receive the response from the terminals for a long time, and then the users may mistakenly believe that the terminals do not receive the interaction information, and then repeatedly input the interaction information to the terminals for many times. As the input interaction information increases, the time for the terminals to process the input interaction information is greatly increased, which seriously affects the user experience. Meanwhile, the response of the terminals to the interaction information input by the users is relatively simple, so that the users cannot obtain the response that the terminals have received the interaction information in time, which affects the user experience.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a specific process of a method for human-machine interaction according to a first embodiment of the present disclosure;

FIG. 2 is a schematic view of a specific process of a method for human-machine interaction according to a second embodiment of the present disclosure;

FIG. 3 is a schematic view showing a specific structure of an apparatus for human-machine interaction according to a third embodiment of the present disclosure; and

FIG. 4 is a schematic view showing a specific structure of a terminal according to a fourth embodiment of the present disclosure.

### DESCRIPTION OF EMBODIMENTS

The present disclosure will be further illustrated with reference to the accompanying drawings and the embodiments.

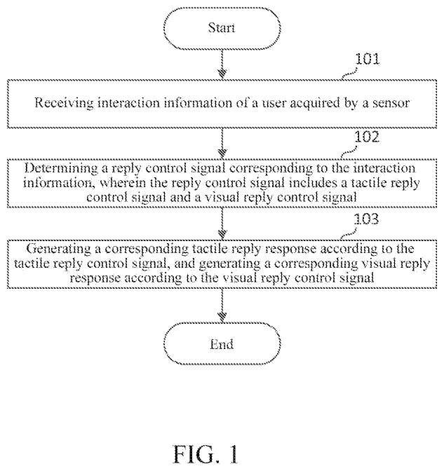

A first embodiment of the present disclosure relates to a method for human-machine interaction, which is applied to a terminal, for example, a smart phone, a smart tablet, a smart in-vehicle device, etc. A specific process of the method for human-machine interaction is as shown in FIG. 1.

Step 101, receiving interaction information of a user acquired by a sensor, wherein the sensor includes a sensor acquiring the interaction information by means of a touch manner.

Particularly, the terminal acquires the interaction information of the user by a sensor, and the sensor includes a sensor that acquires the interaction information by means of the touch manner, for example, a touch sensor, a pressing sensor, and the like. The sensor obtains a touch action of the user, that is, the interaction information of the user. For example, if the sensor is the touch sensor and if a touch duration of the user, which is obtained by the sensor, is 2 seconds, the interaction information of the user is the “touch duration 2S”.

Certainly, the touch manner in this embodiment may be pressing, touching or tapping. It can be understood that the sensor can also acquire the interaction information input by the user in a manner of sliding along a fixed path, the manner of acquiring interaction information can be particularly set according to actual needs. The present disclosure does not limit the touch manner.

In step 102, determining a reply control signal corresponding to the interaction information, wherein the reply control signal includes a tactile reply control signal and a visual reply control signal.

Particularly, each piece of interaction information has a corresponding reply control signal. In order to make each piece of interaction information have a corresponding reply control signal, an executable reply control signal may be randomly generated by a random algorithm, and a corresponding relationship between the interaction information and the generated reply control signal may be stored. If the interaction information is received again, the reply control signal is searched from the stored corresponding relationship firstly. If no reply control signal is found, the corresponding executable reply control signal is randomly generated. Otherwise, the reply control signal in the stored corresponding relationship is acquired. For example, if the interaction information 1 is acquired at time T1 and if the corresponding relationship of the interaction information 1 is not stored in the terminal, the corresponding reply control signal A is randomly generated, and the corresponding relationship between the interaction information 1 and the control signal A is stored. If the interaction information 1 is received at time T2, it is determined, according to the stored corresponding relationship, that the corresponding reply control signal is the reply control signal A, without randomly generating the reply control signal, wherein the T1 time is earlier than the T2 time.

Step 103, generating a corresponding tactile reply response according to the tactile reply control signal, and generating a corresponding visual reply response according to the visual reply control signal, wherein the tactile reply response is used to provide the user with a response action for a touch stimulus, and the visual reply response is used to provide the user with a visible response action.

Particularly, the tactile reply control signal is used to control a corresponding tactile stimulus generation module to generate a tactile stimulus, and the visual reply control signal is used to control a corresponding visual stimulus generation module to generate a corresponding visible response action. The tactile reply response includes vibration, and the visual reply response includes emission of visible light. The vibration can be generated by a vibrator, the visible light can be generated by a light source. Different tactile reply control signals can correspond to different vibration intensities, and different visual reply control signals can correspond to different brightness. For example, the tactile reply control signal 1 corresponds to the vibration intensity of 10 Hz, and the tactile reply control signal 2 corresponds to the vibration intensity of 100 Hz. The visual reply control signal 1 corresponds to of the light brightness of 1 cd/m², and the visual reply control signal 2 corresponds to the light brightness of 2 cd/m².

Certainly, the tactile reply response may also be a tactile stimulus that produces a slight electric shock by a small current flowing through the skin, or a hot tactile stimulus that produces heat by raising the temperature of a certain module, or the like. The visual reply response may be to generate a visible image or generate a projection. The present disclosure does not limit the tactile reply response and the visual reply response, which may be particularly selected according to actual needs.

It should be noted that the tactile reply response and the visual reply response should be performed simultaneously to improve the recognition degree of the user to the reply response of the interaction information through two different sensory stimuli.

In addition, it is worth mentioning that the response action of the visible light can be responded by at least one light source. For example, there can be two light sources, three light sources, and the like. The more the number of the light sources is, the more the number of the manners of obtaining the visual reply response is, that is, the combination of light emitted from different light sources produces different illumination effects.

Compared with the prior art, the embodiments of the present disclosure have the advantages that the sensor acquires the interaction information by means of a touch manner with a high speed. Meanwhile, the terminal can determine the corresponding reply control signal according to the interaction information, thereby generating a reply response corresponding to the interaction information, preventing the user from repeatedly inputting the interaction information for many times due to long-term unresponsiveness, and improving the degree of satisfaction of the user. Since the reply response corresponding to the interaction information is a combination of tactile and visual reply response actions, the user is prevented from ignoring the reply response due to no perception of the single response, so that the user can punctually find the reply response of the interaction information, and the user experience is improved.

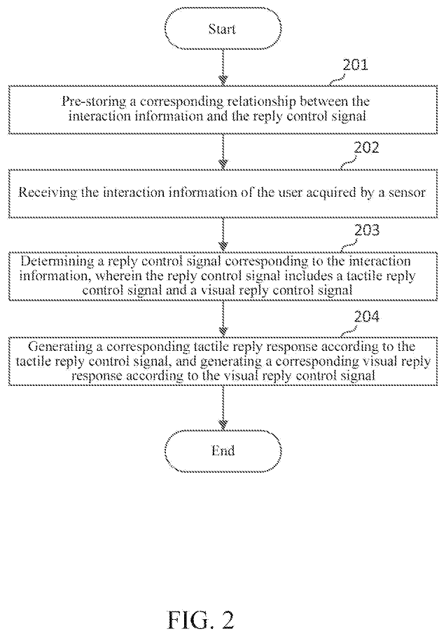

A second embodiment of the present disclosure relates to a method for human-machine interaction. This embodiment is an improvement of the first embodiment, with a main improvement in that, in this embodiment, before the interaction information of the user acquired by the sensor is received, the corresponding relationship between the interaction information and the reply control signal is pre-stored. A specific process is shown in FIG. 2.

Step 201, pre-storing a corresponding relationship between the interaction information and the reply control signal.

Particularly, the engineer can set corresponding reply control signals for different pieces of interaction information and store corresponding relationships between the reply control signals and the different pieces of interaction information. For example, an operation for pressing corresponds to a reply control signal A, an operation for touch 1S corresponds to a reply control signal B, and an operation for continuous tapping 3 times corresponds to a reply control signal C, and the above three corresponding relationships are stored. Certainly, the stored corresponding relationships should be as much as possible, so that the probability of occurrence of the same reply control signal can be effectively reduced. It can be understood that the corresponding relationships can be directly stored in the terminal, or can be stored in a cloud or a server (the terminal is communicatively connected with the cloud, or the terminal is communicatively connected with the server, and the terminal obtains the stored corresponding relationships through a communication connection), or can be stored in the terminal and in the cloud (or the server), which is not limited here and may be particularly selected according to actual needs.

It should be noted that the step 201 may be performed only once during the first human-machine interaction, and then may not be performed during the subsequent human-machine interaction operation. Alternatively, the corresponding relationships may be stored before the interaction information of the user is received for each time, so that the corresponding relationships can be updated, which may be particularly selected according to actual conditions, and is not limited in the present disclosure.

Step 202, receiving the interaction information of the user acquired by a sensor, wherein the sensor includes a sensor acquiring the interaction information by means of a touch manner.

Step 203, determining a reply control signal corresponding to the interaction information, wherein the reply control signal includes a tactile reply control signal and a visual reply control signal.

In a specific implementation, the reply control signal corresponding to the interaction information is searched for from the corresponding relationship, if the reply control signal is found, the found reply control signal is acquired, otherwise, a default reply control signal is adopted.

Particularly, the reply control signal corresponding to the interaction information of the user may be searched by traversing all the corresponding relationships stored. If the corresponding reply control signal is not found after all the corresponding relationships are traversed, the default reply control signal is adopted. If the reply control signal is found, the found reply control signal is acquired. For example, it is assumed that there are three corresponding relationships. The corresponding relationship 1 is as follows: interaction information A corresponds to a reply control signal A. The corresponding relationship 2 is as follows: interaction information B corresponds to a reply control signal B. The corresponding relationship 3 is as follows: interaction information C corresponds to a reply control signal C. A default reply control signal is D. If the reply control signal corresponding to the interaction information B is found from the corresponding relationship 2 by traversing the corresponding relationship, in order to acquire the interaction information B, the corresponding reply control signal B is acquired. If no corresponding reply control signal is found by traversing three corresponding relationships, in order to deal with interaction information E, the default reply control signal D is adopted.

Certainly, the default reply control signal should be pre-stored. Similarly, the default reply control signal can be stored in the terminal, or may be stored in the cloud (or the server), or both.

Step 204, generating a corresponding tactile reply response according to the tactile reply control signal, and generating a corresponding visual reply response according to the visual reply control signal, wherein the tactile reply response is used to provide the user with a response action for a touch stimulus, and the visual reply response is used to provide the user with a visible response action.

It should be noted that the step 202 and the step 204 in this embodiment are substantially the same as the steps 101 and 103 in the first embodiment, which will be omitted here.

It is worth mentioning that the sensor in the terminal may further include one or a combination of a temperature sensor, a photosensitive sensor and a humidity sensor. If the sensor includes a plurality of sensors, it is necessary to jointly determine the corresponding reply control signals according to the interaction information acquired by each sensor. A process of determining response control information corresponding to the interaction information is substantially the same as the method in the step 203.

If the sensor further includes the temperature sensor, the acquired interaction information includes interaction information of the user acquired by means of a touch manner and a temperature value obtained by the temperature sensor. Similarly, the corresponding relationship between the interaction information and the reply control signal is a corresponding relationship among the interaction information acquired by means of the touch manner, the temperature value, and the reply control signal. The temperature value and the interaction information acquired by means of the touch manner jointly determine the reply control signal, and the temperature value obtained by the temperature sensor is in direct proportion to the intensity of the tactile reply response generated by the interaction information acquired by means of the touch manner. For example, if the interaction information acquired by means of the touch manner in the interaction information A and the interaction information B is the same, and the temperature value in the interaction information A is greater than the temperature value in the interaction information B, the intensity of the tactile reply response generated by the reply control signal determined by the interaction information A is greater than the intensity of the tactile reply response generated by the reply control signal corresponding to the interaction information B.

If the sensor further includes the photosensitive sensor, the interaction information includes the interaction information of the user, which is acquired by means of the touch manner and a light intensity value obtained by the photosensitive sensor. The light intensity value obtained by the photosensitive sensor is in direct proportion to the intensity of the visual reply response generated by the interaction information acquired by means of the touch manner. That is, if the interaction information acquired by means of the touch manner in the two pieces of interaction information is the same, and the light intensity values are different, the intensity of the visual reply response generated by the corresponding reply control signal with a high light intensity value is greater than the intensity of the visual reply response generated by the corresponding reply control signal with a low light intensity value. For example, if the user touches the terminal when the light intensity is 1 cd/m², then the light intensity responded according to the interaction information is 2 cd/m². If the user touches the terminal when the light intensity is 2 cd/m², then the light intensity responded according to the interaction information is 4 cd/m².

If the sensor further includes the humidity sensor, and the humidity value obtained by the humidity sensor reaches a preset value, the visual reply response further includes a visual response for reflecting the humidity value. Particularly, the humidity sensor obtains humidity of an environment around the terminal. If the humidity value is too high or too low, it will affect the response of the terminal. Therefore, the user can be reminded to pay attention to the humidity in the environment around the terminal in a special manner. For example, the humidity value can be projected particularly or directly displayed on a screen of the terminal. The preset value can be a humidity critical value that affects the terminal.

The method for human-machine interaction in this embodiment may increase, by pre-storing the corresponding relationship between the interaction information and the reply control signal, the speed of determining the reply control signal, thereby increasing the reply response speed of the terminal to the interaction information. Meanwhile, a combination mode of different sensors can enhance the response degree of the terminal to the interaction information, thereby enabling the application response to be adjusted according to the environment around the terminal, so that the user can quickly find the response of the interaction information.

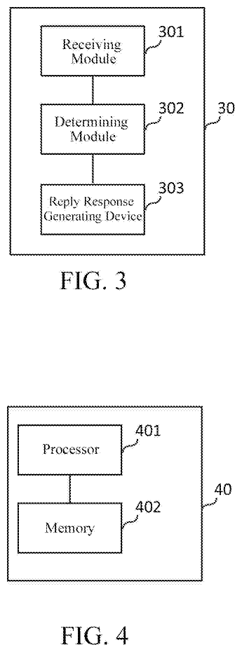

A third embodiment of the present disclosure relates to an apparatus for human-machine interaction. The apparatus 30 includes a receiving device 301, a determining device 302, and a reply response generating device 303. A specific structure of the apparatus is shown in FIG. 3.

The receiving device 301 is configured to receive interaction information of a user acquired by a sensor, wherein the sensor includes a sensor that acquires the interaction information by means of a touch manner. The determining device 302 is configured to determine a reply control signal corresponding to the interaction information, wherein the reply control signal includes a tactile reply control signal and a visual reply control signal. The reply response generating device 303 is configured to generate a corresponding tactile reply response according to the tactile reply control signal, and generate a corresponding visual reply response according to the visual reply control signal, wherein the tactile reply response is used to provide the user with a response action for a tactile stimulus, and the visual reply response is used to provide the user with a visible response action.

Particularly, the receiving device 301 is connected with the sensor, the determining device 302 is connected with the receiving device 301, and the reply response generating device 303 is connected with the determining device 302. The receiving device 301 and the sensor may be connected in a wired manner or a wireless manner, which is not limited in this embodiment.

It is apparent that this embodiment is an apparatus embodiment corresponding to the first embodiment. This embodiment can be implemented in cooperation with the first embodiment. The related technical details mentioned in the first embodiment are still effective in this embodiment, which will be omitted here in order to reduce the repetition. Accordingly, the related technical details mentioned in this embodiment can also be applied to the first embodiment.

It is worth mentioning that each module involved in this embodiment is a logic module. In practical applications, a logical unit may be a physical unit, or may be a part of a physical unit, or may be implemented by a combination of multiple physical units. Furthermore, in order to highlight the innovative part of the present disclosure, this embodiment does not introduce a unit that is not closely related to solving the technical problem proposed by the present disclosure, but this does not mean that there are no other units in this embodiment.

A fourth embodiment of the present disclosure relates to a terminal, including at least one processor 401; and a memory 402 communicably connected with the at least one processor 401, wherein the memory 402 stores an instruction executable by the at least one processor 401, and the instruction is executed by the at least one processor 401 to enable the at least one processor 401 to perform the method for human-machine interaction described above. A specific structure is as shown in FIG. 4.

The memory 402 and the processor 401 are connected via a bus. The bus may include any number of interconnected buses and bridges. The bus links various circuits of the one or more processors 401 and the memory 402 together. The bus can also link various other circuits such as peripheral devices, voltage regulators, and power management circuits together, as is well known in the art and therefore, will be omitted here. A bus interface provides an interface between the bus and a transceiver. The transceiver can be an element or a plurality of elements, such as a plurality of receivers and transmitters, providing a unit for communicating with various other apparatuses on a transmission medium. Data processed by the processor 401 is transmitted over a wireless medium via an antenna. Further, the antenna also receives the data and transmits the data to the processor 401.

The processor 401 is responsible for managing the bus and usual processes, and can further provide various functions including timing, peripheral interfaces, voltage regulation, power management, and other control functions. The memory can be used to store data used by the processor when performing operations.

A fifth embodiment of the present disclosure relates to a computer-readable storage medium storing a computer program, when is executed by the processor, the computer program can implement the method for human-machine interaction mentioned in the first or second embodiment.

It will be understood by those skilled in the art that all or a part of steps in the method of the above embodiments can be done by instructing the relevant hardware through a program stored in a storage medium, the program includes a number of instructions to enable a device (which may be a single-chip machine, a chip, etc.) or a processor to perform all or a part of the steps of the method described in the various embodiments of the present disclosure. The aforementioned storage medium includes a U disk, a mobile hard disk, a read-only memory, a random access memory, a disk or a CD-ROM, which can store programming codes.

It will be understood by those ordinarily skilled in the art that the above embodiments are specific embodiments implementing the present disclosure, and in practical applications, various changes can be made in form and detail without departing from the spirit and scope of the present disclosure.

What is claimed is:

1. A method for human-machine interaction, applied to a terminal, the method comprising:
receiving interaction information of a user acquired by a sensor, the sensor acquiring the interaction information by means of a touch manner;
determining a reply control signal corresponding to the interaction information, the reply control signal comprising a tactile reply control signal and a visual reply control signal; and
generating a tactile reply response according to the tactile reply control signal, and generating a visual reply response according to the visual reply control signal,
wherein the tactile reply response is used for providing a response action for a tactile stimulus to the user, and the visual reply response is used for providing a visible response action to the user.

2. The method for human-machine interaction as described in claim 1, wherein the tactile reply response comprises vibration, and the visual reply response comprises emission of visible light.

3. The method for human-machine interaction as described in claim 1, further comprising, prior to receiving interaction information of a user acquired by a sensor:
pre-storing a corresponding relationship between the interaction information and the reply control signal.

4. The method for human-machine interaction as described in claim 2, further comprising, prior to receiving interaction information of a user acquired by a sensor:
pre-storing a corresponding relationship between the interaction information and the reply control signal.

5. The method for human-machine interaction as described in claim 3, wherein said determining a reply control signal corresponding to the interaction information comprises:
searching for the reply control signal corresponding to the interaction information from the corresponding relationship, if the reply control signal is found, acquiring the found reply control signal, otherwise, adopting a default reply control signal.

6. The method for human-machine interaction as described in claim 4, wherein said determining a reply control signal corresponding to the interaction information comprises:
searching for the reply control signal corresponding to the interaction information from the corresponding relationship, if the reply control signal is found, acquiring the found reply control signal, otherwise, adopting a default reply control signal.

7. The method for human-machine interaction as described in claim 2, wherein the emission of visible light is performed by at least one light source.

8. The method for human-machine interaction as described in claim 1, wherein the touch manner comprises pressing, touching or tapping.

9. The method for human-machine interaction as described in claim 2, wherein the touch manner comprises pressing, touching or tapping.

10. The method for human-machine interaction as described in claim 5, wherein the sensor further comprises one or a combination of a temperature sensor, a photosensitive sensor and a humidity sensor;
if the sensor comprises the temperature sensor, a temperature value obtained by the temperature sensor is directly proportional to an intensity of the tactile reply response generated by the interaction information acquired by means of the touch manner;
if the sensor comprises the photosensitive sensor, a light intensity value obtained by the photosensitive sensor is directly proportional to an intensity of the visual reply response generated by the interaction information acquired by means of the touch manner; and
if the sensor further comprises the humidity sensor, when a humidity value obtained by the humidity sensor reaches a preset value, the visual reply response further comprises reflection of the humidity value.

11. The method for human-machine interaction as described in claim 6, wherein the sensor further comprises one or a combination of a temperature sensor, a photosensitive sensor and a humidity sensor;
if the sensor comprises the temperature sensor, a temperature value obtained by the temperature sensor is directly proportional to an intensity of the tactile reply response generated by the interaction information acquired by means of the touch manner;
if the sensor comprises the photosensitive sensor, a light intensity value obtained by the photosensitive sensor is directly proportional to an intensity of the visual reply response generated by the interaction information acquired by means of the touch manner; and
if the sensor further comprises the humidity sensor, when a humidity value obtained by the humidity sensor reaches a preset value, the visual reply response further comprises reflection of the humidity value.

12. The method for human-machine interaction as described in claim 7, wherein the sensor further comprises one or a combination of a temperature sensor, a photosensitive sensor and a humidity sensor;
if the sensor comprises the temperature sensor, a temperature value obtained by the temperature sensor is directly proportional to an intensity of the tactile reply response generated by the interaction information acquired by means of the touch manner;
if the sensor comprises the photosensitive sensor, a light intensity value obtained by the photosensitive sensor is directly proportional to an intensity of the visual reply response generated by the interaction information acquired by means of the touch manner; and
if the sensor further comprises the humidity sensor, when a humidity value obtained by the humidity sensor reaches a preset value, the visual reply response further comprises reflection of the humidity value.

13. An apparatus for human-machine interaction, comprising:
a receiving device configured to receive interaction information of a user acquired by a sensor, the sensor acquiring the interaction information by means of a touch manner;
a determining device configured to determine a reply control signal corresponding to the interaction information, the reply control signal comprising a tactile reply control signal and a visual reply control signal; and
a reply response generating device configured to generate a tactile reply response according to the tactile reply control signal, and generate a visual reply response according to the visual reply control signal;
wherein the tactile reply response is used for providing a response action for a tactile stimulus to the user, and the visual reply response is used for providing a visible response action to the user.

14. A terminal, comprising:
at least one processor; and
a memory communicatively connected to the at least one processor,
wherein the memory stores an instruction executable by the at least one processor, and the instruction is executed by the at least one processor to enable the at least one processor to perform the method for human-machine interaction as described in claim 1.
